(19) United States
(12) Patent Application Publication
(10) Pub. No.: US 2023/0124288 A1
(43) Pub. Date: Apr. 20, 2023

(54) Responsible Artificial Intelligence Controller

(71) Applicant: Google LLC, Mountain View, CA (US)

(72) Inventors: Kathleen Susan Meier-Hellstern, Cranbury, NJ (US); Marian R. Croak, Fairhaven, NJ (US)

(21) Appl. No.: 17/968,391

(22) Filed: Oct. 18, 2022

Related U.S. Application Data
(60) Provisional application No. 63/257,064, filed on Oct. 18, 2021.

(51) Int. Cl. G06F 9/445; G06F 40/40

(52) U.S. Cl. CPC G06F 9/44536; G06F 40/40

(57) ABSTRACT

Generally, the present disclosure is directed to systems and methods that include and/or leverage a responsible artificial intelligence controller to provide context-specific responsible artificial intelligence control. The responsible AI controller (RAI Controller) is a solution to the problem of a single model that cannot be simultaneously responsible to all its users. The controller embraces the notion of demographic and societal diversity, and it gives the user control over their interaction with the AI system.

### FIELD

The present disclosure relates generally to artificial intelligence. More particularly, the present disclosure relates to systems and methods that include and/or leverage a responsible artificial intelligence controller to provide context-specific responsible artificial intelligence control.

### BACKGROUND

Developing artificial intelligence (AI) systems in a socially responsible manner is central to the long term success of AI. These systems need to meet the needs of all users, independent of demographic or cultural context, in accordance with the principles that govern the application. For example, systems or applications that include or leverage AI should: be socially beneficial; avoid creating or reinforcing unfair bias; be built and tested for safety; be accountable to people; incorporate privacy design principles; uphold high standards of scientific excellence; and be made available for uses that accord with these principles. Conversely, systems or applications that include or leverage AI should not: be likely to cause overall harm; have a principal purpose to direct injury; perform surveillance violating internationally accepted norms; or have a purpose that contravenes international law and human rights. A given system or application will be guided by a set of policies and objectives that attempt to realize the principles described above. These objectives can be referred to as “responsibility objectives.”

There are many published methods used to make AI models more responsible (e.g., make AI models meet the responsibility objectives). As examples: Measurements and benchmarks are used to detect issues with the models. Mitigation techniques may be adopted to remove objectionable content from the training data, or to adjust the model objective function to (for example) reduce bias. Fine tuning can be employed to make the model produce more responsible results. Sometimes, classifiers are used to filter out undesirable context before it reaches the user. However, it is impossible to produce a single model that is simultaneously responsible to all of its users and in all possible contexts.

In particular, while responsibility objectives may be broadly agreed upon, specific understandings of the objectives may differ across demographic and societal contexts. In other cases, the responsibility objectives themselves may differ across contexts. Stated differently, the output of a certain AI model may satisfactorily meet some or all of the responsibility objectives in a first context, but fail to meet some or all of the responsibility objectives in a second context and/or the objectives themselves may be different in different contexts. For example, terminology that is offensive in one societal context may, in a different societal context, not carry the same offensive meaning or underlying interpretation.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform responsible artificial intelligence (AI) control. The method includes receiving, by a computing system comprising one or more computing devices, a user request for output data from an AI system. The method includes determining, by the computing system, context data descriptive of a context associated with the user request. The method includes executing, by the computing system, a responsible AI controller to select one or more selected AI systems from a plurality of available AI systems, each of the plurality of available AI systems comprising one or more AI components. The method includes generating, by the computing system, a respective output from each of the one or more selected AI systems based on the user request. The method includes providing, by the computing system, the output data to the user based on the respective output from one or more of the one or more selected AI systems.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example system that includes a responsible AI controller according to example embodiments of the present disclosure.

FIG. 1B depicts a block diagram of an example RAI controller according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Example Responsible AI Controller

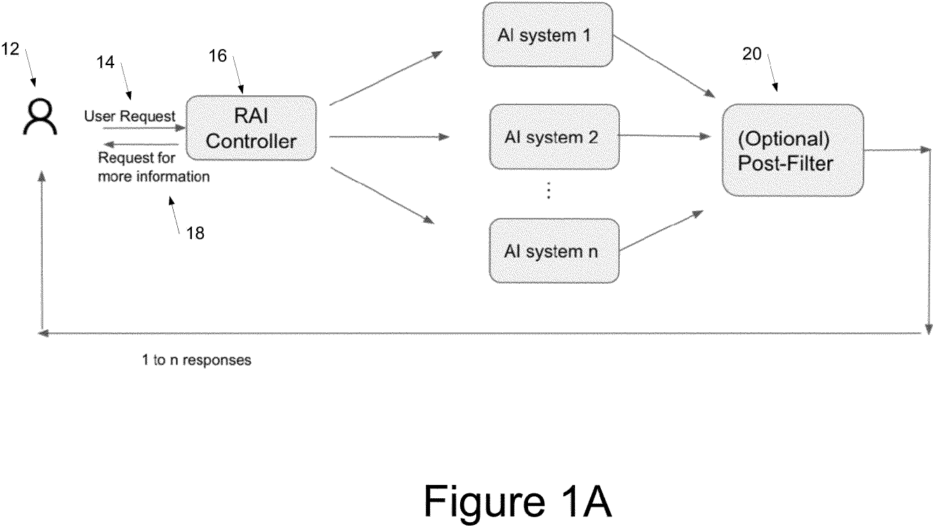

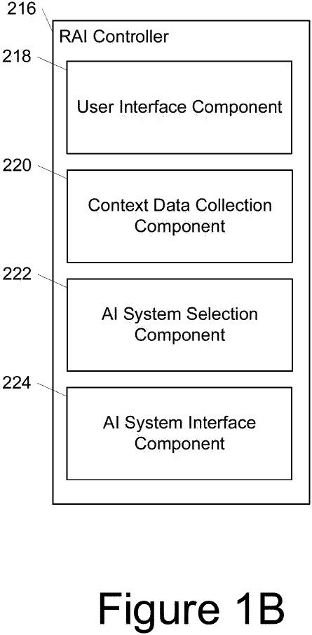

Generally, the present disclosure is directed to systems and methods that include and/or leverage a responsible artificial intelligence controller to provide context-specific responsible artificial intelligence control. The responsible AI controller (RAI Controller) is a solution to the problem of a single model that cannot be simultaneously responsible to all its users. The controller embraces the notion of demographic and societal diversity, and it gives the user control over their interaction with the AI system. FIG. 1A illustrates one example implementation of the concept of the RAI Controller.

Specifically, one example implementation which can leverage an RAI Controller is shown in FIG. 1A and can operate as follows:
1. A user 12 submits a request 14 to an AI system. As one example, the request 14 can be a search query. As another example, the request 14 can be a portion of a dialog or other natural language conversation (e.g., in either textual or speech form), which may, in some instances, include a query or question. For example, the dialog may be occuring between a user and an AI-based assistant or chatbot. As another example, the request 14 can be a request to generate a synthetic image. However, many other example applications are possible and are contemplated by the present disclosure, including various scenarios in which a user is requesting information or content from a system.
2. The request 14 is forwarded to the RAI Controller 16. Optionally, the controller 16 determines that the request may be of a sensitive nature. Thus, in some implementations, the proposed RAI Controller 16 operates to control the AI used to respond to the query only when an initial review determines that the request is a sensitive request. However, in other implementations, the RAI Controller 16 operates to control the AI used to respond to each query regardless of whether it has been designated as sensitive.
3. The RAI Controller 16 determines a context associated with the user request 14. For example, the RAI Controller 16 can interact with the user to obtain additional information related to their request, such as location, demographics, etc. For example, the RAI Controller 16 can send a request for more information 18. There may be a multiplicity of types of additional information that are requested. Alternatively or additionally, the RAI Controller 16 can automatically infer certain context and/or can retrieve stored context data from a user profile or other data store. In some implementations, only context data supplied by the user is used to perform the selection of AI, so that the user has full control over how the request is routed and the corresponding output data that is obtained.
4. The RAI Controller 16 selects one or more of a number of available AI systems (e.g., illustrated in FIG. 1A as AI systems 1, 2, n) to generate outputs based on the user request. Thus, in some implementations, the RAI Controller 16 uses the information gathered to determine how to route the request to one or more AI systems that are specialized to the context and that will provide more relevant information to the user. The determination of which system to route the request to may be made using an AI or other application implemented by the Controller 16, or the routing may be performed deterministically. Thus, in some implementations, the AI Controller 16 may itself be a learned component, while in other implementations the AI Controller 16 may implement certain deterministic rules to select the appropriate AI system. In some implementations, the user can be supplied with an indication of which of the available AI system(s) were selected and why.
5. Based on the user-supplied information and the sensitivity, the RAI Controller 16 forwards the request to the selected one or more AI systems. For example, the selected AI system(s) can be systems that have been designed, trained, or otherwise believed to be most appropriate to handle sensitive requests for the societal context and sensitivity that have been determined. The selected AI system(s) may be co-located or remote from the Controller 16. The selected AI system(s) may be under the control of the Controller 16 or may be independent from the Controller 16. In some instances, some or all of the AI systems may be interacted with using one or more application programming interfaces (APIs).
6. The selected AI system(s) that are handling the user requests may be constructed using a variety of techniques, including but not limited to: model training with context-specific data, fine-tuning, filtering with classifiers designed to detect “unsafe” content, prompt-based learning, prompt engineering, in-context learning, and few-shot learning. The AI systems may be embodied as a multiplicity of AI systems, or there may be a single AI system that is dynamically adapted to the user context and sensitivity. As one example, the AI systems may be embodied as a single large language model that can be queried using one or more of a number of different prompts. Thus, in this example, the RAI Controller 16 may select the appropriate prompt to use to query the language model with the user request 14 given the determined context. In another example, the plurality of available AI systems may respectively correspond to a plurality of classification filters that have been respectively designed to detect and filter undesirable content associated with a plurality of different contexts. In some examples, the filtering can be based on user data such as user demographic data. In implementations in which the RAI Controller 16 is a learned component, it may be learned jointly with the available AI systems or can be learned independently of such systems.
7. Each of the selected AI system(s) prepares a response to the user request 14 (which has potentially been modified by the RAI Controller 16). As an example, the response may be a set of context-specific search results. As another example, the response may be a language output that is responsive to a language input contained in the request 14. However, many other and different applications are possible and contemplated by the present disclosure.
8. The responses could be delivered to the user as a multiplicity of responses, or there might be an optional post-filter 20 designed to select the most appropriate user response.

FIG. 1B depicts a block diagram of an example RAI controller 216 according to example embodiments of the present disclosure. As illustrated in FIG. 1B, the example RAI controller 216 includes a user interface component 218, a context data collection component 220, an AI system selection component 222, and an AI system interface component 224.

The user interface component 218 can receive a request from a user. As one example, the request can be a search query. As another example, the request can be a portion of a dialog or other natural language conversation (e.g., in either textual or speech form), which may, in some instances, include a query or question. However, many other example applications are possible and are contemplated by the present disclosure, including various scenarios in which a user is requesting information or content from a system.

Optionally, the user interface component 218 determines that the request may be of a sensitive nature. Thus, in some implementations, the RAI Controller 216 operates to control the AI used to respond to the query only when an initial review determines that the request is a sensitive request. However, in other implementations, the RAI Controller 216 operates to control the AI used to respond to each query regardless of whether it has been designated as sensitive.

The context data collection component 220 determines a context associated with the user request. For example, the context data collection component 220 can interact with the user to obtain additional information related to their request, such as location, demographics, etc. For example, the context data collection component 220 can send (via the user interface component 218) a request for more information. There may be a multiplicity of types of additional information that are requested. Alternatively or additionally, the context data collection component 220 can automatically infer certain context and/or can retrieve stored context data from a user profile or other data store. In some implementations, only context data supplied by the user is used to perform the selection of AI, so that the user has full control over how the request is routed and the corresponding output data that is obtained.

The AI system selection component 222 selects one or more of a number of available AI systems to generate outputs based on the user request. Thus, in some implementations, the AI system selection component 222 uses the information gathered by the context data collection component 220 to determine how to route the request to one or more AI systems that are specialized to the context and that will provide more relevant information to the user. The AI system selection component 222 may include a machine-learned model or other application implemented by the Controller 216, or the AI system selection component 222 may execute deterministic rules or logic. Thus, in some implementations, the AI system selection component 222 may itself be a learned component, while in other implementations the AI system selection component 222 may implement certain deterministic rules to select the appropriate AI system. In some implementations, the user can be supplied with an indication of which of the available AI system(s) were selected and why.

Based on the user-supplied information and the sensitivity, the AI system interface component 224 forwards the request to the selected one or more AI systems. For example, the selected AI system(s) can be systems that have been designed, trained, or otherwise believed to be most appropriate to handle sensitive requests for the societal context and sensitivity that have been determined. The selected AI system(s) may be co-located or remote from the Controller 216. The selected AI system(s) may be under the control of the Controller 216 or may be independent from the Controller 216. In some instances, some or all of the AI systems may be interacted with using one or more application programming interfaces (APIs).

Each of the selected AI system(s) prepares a response to the user request (which has potentially been modified by the RAI Controller 216). As an example, the response may be a set of context-specific search results. As another example, the response may be a language output that is responsive to a language input contained in the request. However, many other and different applications are possible and contemplated by the present disclosure. The AI system interface component 224 can receive the responses from the selected AI system(s).

The user interface component 218 can deliver the responses to the user as a multiplicity of responses, or there might be an optional post-filter designed to select the most appropriate user response.

### Example Devices and Systems

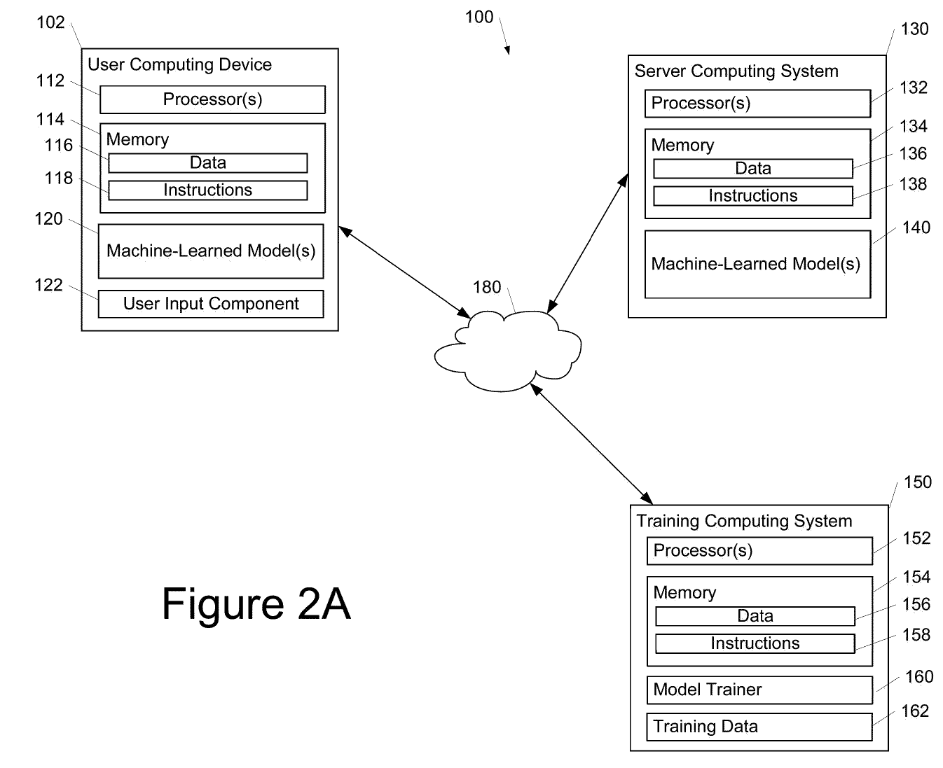

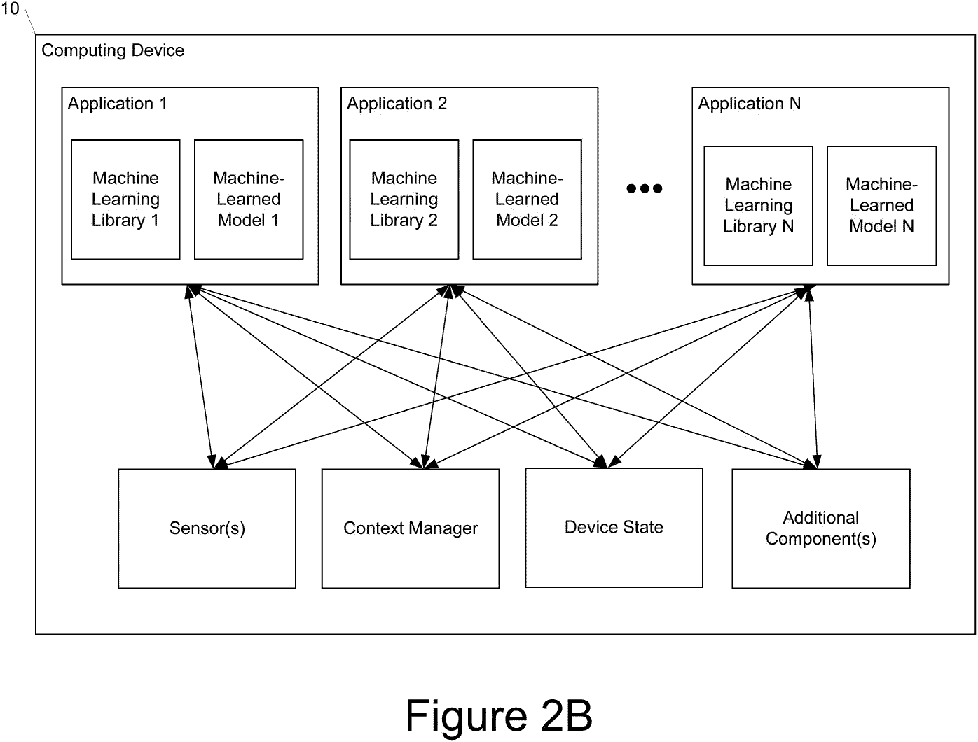

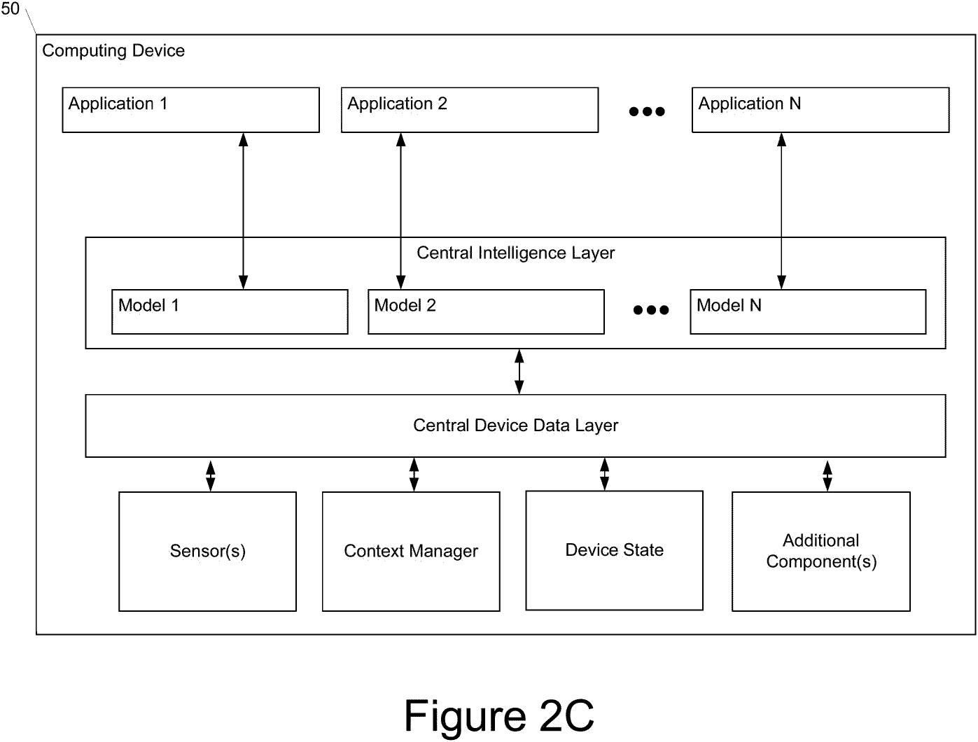

FIG. 2A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

Thus, the RAI controller and AI systems described herein can be executed at various permutations of computing location(s). As one example, the RAI controller and the AI systems can be implemented at the user computing device 102 (e.g., in an “on-device” fashion). As another example, the RAI controller can be implemented at the user computing device 102 while the AI systems can be implemented by one or more server computing systems (e.g., system 130). As yet another example, the RAI controller and the AI systems can be implemented by one or more server computing systems (e.g., by system 130 as a service). In yet another example, a set of one or more on-device machine learning models can generate a set of “characteristics” for a person, that are then used by the RAI controller (e.g., which may be located in the cloud) in selecting the best back-end AI system

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform responsible artificial intelligence (AI) control, the method comprising:
receiving, by a computing system comprising one or more computing devices, a user request for output data from a user;
determining, by the computing system, context data descriptive of a context associated with the user request;
executing, by the computing system, a responsible AI controller to select one or more selected AI systems from a plurality of available AI systems, each of the plurality of available AI systems comprising one or more AI components;
generating, by the computing system, a respective output from each of the one or more selected AI systems based on the user request; and
providing, by the computing system, the output data to the user based on the respective output from one or more of the one or more selected AI systems.

2. The computer-implemented method of claim 1, wherein determining, by the computing system, the context data descriptive of the context associated with the user request comprises:
querying, by the computing system, the user for the context data; and
receiving, by the computing system, the context data from the user responsive to said querying.

3. The computer-implemented method of claim 1, wherein determining, by the computing system, the context data descriptive of the context associated with the user request comprises automatically inferring the context data.

4. The computer-implemented method of claim 1, wherein said determining the context data and said executing the responsible AI controller to select the one or more selected AI systems are performed in response to a determination, by the computing system, that the user request comprises a sensitive request.

5. The computer-implemented method of claim 1, wherein the context data comprises user location data and/or user demographic data associated with the user.

6. The computer-implemented method of claim 1, wherein the responsible AI controller comprises a machine-learned model.

7. The computer-implemented method of claim 1, wherein the responsible AI controller comprises a set of deterministic rules.

8. The computer-implemented method of claim 1, wherein the plurality of available AI systems respectively comprise a plurality of machine-learned models that have been respectively trained using a plurality of different training datasets that are respectively associated with a plurality of different contexts.

9. The computer-implemented method of claim 1, wherein the plurality of available AI systems respectively comprise a plurality of machine-learned models that have been respectively fine-tuned using a plurality of different finetuning datasets that are respectively associated with a plurality of different contexts.

10. The computer-implemented method of claim 1, wherein the plurality of available AI systems respectively comprise a plurality of classification filters that have been respectively designed to detect and filter undesirable content associated with a plurality of different contexts.

11. The computer-implemented method of claim 1, wherein the plurality of available AI systems respectively comprise a plurality of different model prompts that are respectively associated with a plurality of different contexts.

12. The computer-implemented method of claim 1, wherein the plurality of available AI systems comprise a plurality of different and distinct AI systems.

13. The computer-implemented method of claim 1, wherein the plurality of available AI systems comprise a single AI system that is dynamically adaptable to a plurality of different and distinct behaviors.

14. The computer-implemented method of claim 1, wherein providing, by the computing system, the output data to the user based on the respective output from one or more of the one or more selected AI systems comprises providing as the output data to the user all of the respective outputs from all of the selected AI systems.

15. The computer-implemented method of claim 1, wherein providing, by the computing system, the output data to the user based on the respective output from one or more of the one or more selected AI systems comprises:
filtering all of the respective outputs from all of the selected AI systems to generate a final subset of one or more outputs; and
providing the final subset as the output data to the user.

16. The computer-implemented method of claim 1, wherein:
the user request comprises a search query; and
the output data comprises one or more search results responsive to the search query.

17. A computing system comprising:
one or more processors;
a responsible AI controller; and
one or more non-transitory computer-readable media that store instructions that, when executed, cause the computing system to perform operations, the operations comprising:
receiving, by the computing system, a user request for output data from a user;
determining, by the computing system, context data descriptive of a context associated with the user request;
executing, by the computing system, the responsible AI controller to select one or more selected AI systems from a plurality of available AI systems, each of the plurality of available AI systems comprising one or more AI components;
generating, by the computing system, a respective output from each of the one or more selected AI systems based on the user request; and
providing, by the computing system, the output data to the user based on the respective output from one or more of the one or more selected AI systems.

18. One or more non-transitory computer-readable media that store instructions that, when executed, cause a computing system to perform operations, the operations comprising:
receiving, by the computing system, a user request for output data from a user;
determining, by the computing system, context data descriptive of a context associated with the user request;
executing, by the computing system, the responsible AI controller to select one or more selected AI systems from a plurality of available AI systems, each of the plurality of available AI systems comprising one or more AI components;
generating, by the computing system, a respective output from each of the one or more selected AI systems based on the user request; and
providing, by the computing system, the output data to the user based on the respective output from one or more of the one or more selected AI systems.
